(19) United States
(12) Patent Application Publication
(10) Pub. No.: US 2003/0028370 A1
(43) Pub. Date: Feb. 6, 2003

(54) System and method for providing a fixed grammar to allow a user to create a relational database without programming

(76) Inventor: Adam E. Leffert, Chestnut Hill, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/209,225

(22) Filed: Jul. 31, 2002

Related U.S. Application Data
(60) Provisional application No. 60/309,986, filed on Aug. 3, 2001.

(51) Int. Cl. G06F 17/21

(52) U.S. Cl. 704/10

(57) ABSTRACT

A system for generating a relational database based on a fixed set of statement types. Each statement type defines a permitted relationship between a subject noun type, a verb, and an object noun type. The statement types are the basis for user defined statements. Each user-defined statement links a subject noun with an object noun by way of a verb. In addition, each statement may contain one or more prepositional phrases, consisting of a preposition type and an object of preposition noun. The preposition types and object of preposition noun types are defined by a fixed set of prepositional phrase types. The user defined statements represent the user's relational database, and form the basis for responding to various user queries. Statements are defined through a number of steps, during which the statement types are used to control the user's selections as to subject noun, verb, and object noun. Fixed sets of noun types, verbs, and preposition types effectively group the nouns and statements that are present in the database into categories, and enhance the convenience of the system by explicitly categorizing the items in the database (the nouns) and clearly representing facts about those items (the statements) in a way that allows for quick and easy database creation and querying, from both the human and computer perspectives.

### CROSS REFERENCE TO RELATED APPLICATIONS

This application claims priority under 35 U.S.C. §119(e) to provisional patent application serial No. 60/309,986 filed Aug. 3, 2001.

### STATEMENT REGARDING FEDERALLY SPONSORED RESEARCH OR DEVELOPMENT

N/A

### BACKGROUND OF THE INVENTION

The present invention relates generally to systems for generating databases, and more specifically to a system and method for providing a fixed grammar to allow a user to create a relational database without programming.

The present invention differs from and provides multiple advantages over existing technologies, which may be considered categorically. A first category of existing database creation technologies may be generally referred to as “developer tools.” These include relational database management systems (RDBMS) for relatively large databases, such as Oracle, Sybase, SQL Server, Ingres, and MySQL, as well as RDBMS for smaller scale databases, such as Microsoft Access, FileMaker, Fourth Dimension. Some other developer tools are based on object-oriented databases, and are referred to as object-oriented database management systems (ODBMS). Examples of ODBMS include Illustra and Objectivity. Hybrid databases, including object-relational databases, are known as Moreover, a ready to use database for a given area may not be sufficiently flexible for a specific application within that area.

A third category of existing technology is known as natural-language processing software. Many popular World Wide Web search engines (Altavista, Google, Hotbot, etc.) use some sort of natural language-processing as part of their design, while other software packages specialize directly in natural-language processing. Typical search engines analyze the text of Web pages, and attempt to derive meaning from them, for example by applying word counts, statistics and various other algorithms. A user is permitted to enter questions in plain English, or using a simple query language. Often, the target data for the search is large and relatively unorganized, such as the World Wide Web. Accordingly, the results returned by these systems vary widely in their relevance to the user's query. Such systems trade effort for accuracy, in that there is little or no work required to administer the target data. For many applications, however, the user's time spent wading through irrelevant results may be prohibitively expensive. Moreover, typical results from existing natural-language processing systems of this type consist of pages of text or other content, each of which themselves may require considerable time for a user to process to determine their relevance.

Other systems that have been used to organize data include knowledge management (KM) software. Knowledge management software is software which creates representations of human knowledge in computer-readable form. The use of knowledge management software is sometimes referred to as “modeling” of the data being stored. Some knowledge management systems employ a natural language for their modeling format. A significant disadvantage of knowledge management systems is that professional assistance is required at each of multiple phases of their operation. This results from the requirement that the model be customized before data entry can occur. For example, knowledge management projects often begin with a survey phase, followed by a design phase, followed by phases of implementation and testing. While the knowledge management professionals that assist in this process (which takes months to years) may not be programmers, they are highly-trained and specialized, and accordingly introduce significant costs and delays to the project.

For these reasons, it would be desirable to have a relational database tool that is suited to computer users who may not have specialized programming skills, but who want to create relational databases containing a wide range of interrelated information. The system should give non-programmers the ability to create relational databases on any topic. Further, the system should be generally useable with a minimum of user training, and provide highly accurate results.

### BRIEF SUMMARY OF THE INVENTION

The disclosed system operates to enable a user to conveniently generate a relational database without programming. During database generation, the disclosed system operates based on a fixed, predetermined set of statement types. Each statement type defines a permitted relationship between a subject noun type, a verb, and an object noun type. The statement types are the basis for user defined statements, each of which link a subject noun with an object noun by way of a verb. The disclosed system further enables prepositional phrases to be included within statements, based on predetermined prepositional phrase types. The prepositional phrase types allow the user to qualify statements by specifying, among other things, where, when, or how the statement occurred. The user defined statements represent the user's relational database, and form the basis for responding to various user queries.

The system enables a user to define each statement through a number of steps. First, an interface is provided through which the user can specify a subject noun for the statement. The system operates to provide alternative steps through which the user can specify the subject noun. First, the user may simply enter a new noun that is to be used as the subject noun. Alternatively, the user can select a previously entered noun, for example from a list of nouns, to serve as the subject noun. In either case, the interface derives the noun type associated with the subject noun. The system then obtains user indication of a verb for the statement. The indicated verb must be selected from a fixed, predetermined set of verbs that is displayed to the user. The subject noun type (the type of the subject noun) determines the list of verbs presented to the user, since certain verbs make sense for certain subject noun types.

The fixed, predetermined set of statement types determines this set of meaningful verbs for the subject noun type.

After the user has indicated a subject noun and a verb for a statement, the disclosed system identifies a set of object noun types. Again, the system refers to the predetermined set of statement types to find the list of object noun types that make sense given the subject noun type and verb of the statement.

The user then selects one of the identified set of object noun types as the type of the object noun for the statement being defined. The specific object noun for the statement can then be added by the user, or selected from a set of previously defined nouns of the same type as the selected object noun type.

The user may choose to add one or more prepositional phrases to the statement. There is a fixed set of prepositional phrase types, but a prepositional phrase of any type can be added to any statement.

As described above, the predetermined, fixed sets of noun types and statement types effectively group the nouns and statements into categories. These categories enhance the convenience of the system by providing only a limited set of user choices at one time, as during selection of the nouns and verb for a statement. Moreover, such type-based categories further enhance the use of the resulting database, by enabling convenient querying.

The disclosed system is thus a relational database tool that is well suited to computer users without specialized programming skills. The system facilitates creation of relational databases containing a wide range of interrelated information, on any topic, and with a minimum of user training. Since the fixed grammar does not require customization, there is no costly and time-consuming schema design phase in using the disclosed system.

### BRIEF DESCRIPTION OF THE SEVERAL VIEWS OF THE DRAWINGS

The invention will be more fully understood by reference to the following detailed description of the invention in conjunction with the drawings, of which:

FIG. 1 is a block diagram of components in an illustrative embodiment;

FIGS. 2 through 4 are block diagrams illustrating the representation of data using the disclosed fixed grammar;

FIG. 5 is a logical diagram illustrating examples of noun types, statement types, and prepositional phrase types as in the disclosed fixed grammar;

FIG. 6 is a example of entries in a relational database consisting of user defined statements;

FIG. 7 is a flow chart showing steps performed by prior art systems to create a relational database;

FIG. 8 is a flow chart showing steps performed by an embodiment of the disclosed system to create a relational database;

FIGS. 9 and 10 are screen displays illustrating operation of the disclosed system to browse data stored in a database generated using the disclosed system;

FIGS. 11 through 19 are screen displays illustrating operation of the disclosed system to enter data into a database;

FIG. 20 is a screen display illustrating how to browse items in a database using the disclosed system; and

FIGS. 21 through 23 are screen displays illustrating how user defined statements can be found using the disclosed system.

### DETAILED DESCRIPTION OF THE INVENTION

All disclosures of U.S. provisional patent application No. 60/309,986, filed Aug. 3, 2001, and entitled “SYSTEM AND METHOD FOR PROVIDING A FIXED GRAMMAR TO ALLOW A USER TO CREATE A RELATIONAL DATABASE WITHOUT PROGRAMMING,” are hereby incorporated herein by reference.

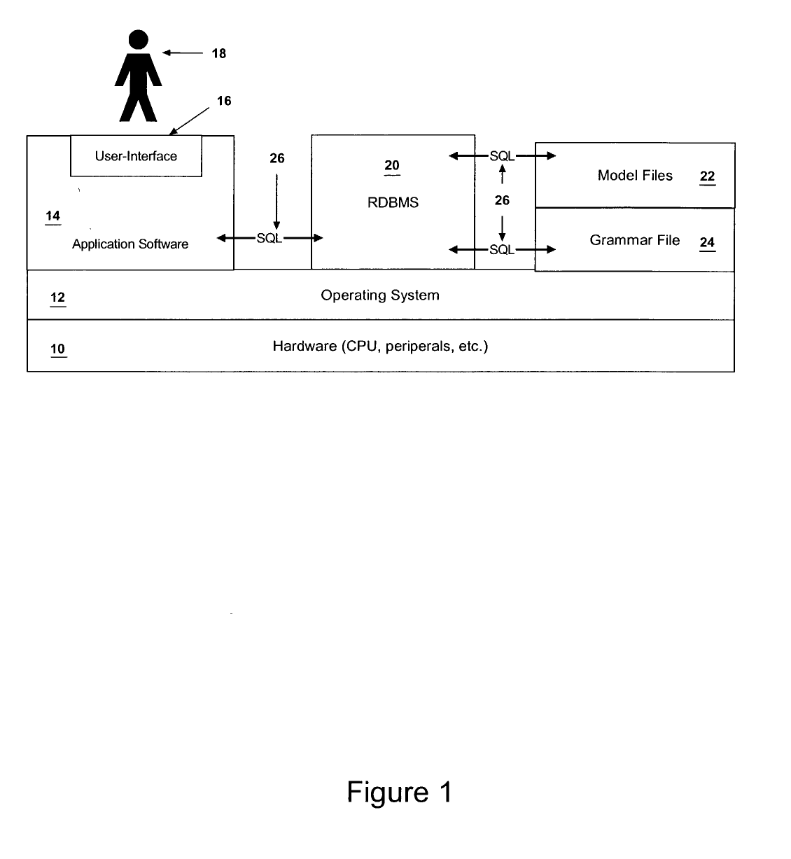

As shown in FIG. 1, an embodiment of the disclosed system operates as software in a computer system. FIG. 1 shows computer hardware 10, including one or more processors, such as a central processing unit (CPU) and various peripheral or input/output (I/O) devices. For example, the computer hardware 10 may include various types of computer program storage, such as a memory and/or one or more disc drives. An operating system 12 is shown interfacing between the computer hardware 10 and other software. The operating system 12 may consist, for example, of any conventional operating system software, such as one of the Windows® operating systems provided by Microsoft® Corporation, or any other operating system.

Further in FIG. 1, the disclosed system is shown including application software 14, which communicates with the hardware 10 through the operating system 12. As shown in FIG. 1, the application software 14 may run on a local computer system as single user software. Alternatively, the disclosed system may be embodied as software running in a networked computer environment, as multi-user software running on one or more server systems connected to a local-area network (LAN) . In another embodiment, the disclosed system may be embodied as Web server software to which a user on a client system connects via a Web browser program, such as Netscape Navigator® or Microsoft Explorer®. In still another embodiment, the disclosed system may be embodied as software executing on a Personal Digital Assistant (PDA) or mobile phone.

The application software 14 communicates with a user 18 through a graphical user interface 16. The user 18 communicates with the application software 14 through the user interface 16, by defining nouns and statements to the application software 14 through the user interface 16, and by issuing requests and obtaining results through the user interface 16. The application software 14 stores the data it receives from the user 18 using SQL 26 (Structured Query Language) commands that it passes to a Relational Database Management System (RDBMS) 20. As a result, a number of database tables are populated with the data received from the user. When requests for data are received from the user 18 through the user interface 16, the application software translates the requests into SQL commands, which are then passed to the RDBMS 20 for processing. While the disclosed system takes advantage of the SQL based features and functionality of the RDBMS 20, the user 18 advantageously need not understand SQL to use the disclosed system.

The model files 22 are used to store tables containing the nouns and statements defined and accessed by the user 18 through the user interface 16. The contents of the model files 22 are controlled and modified by the application software 14 through the RDBMS 20 using SQL 26. The grammar file 24 contains a number of tables that define the noun types, statement types, and prepositional phrase types of the fixed grammar employed by the disclosed system.

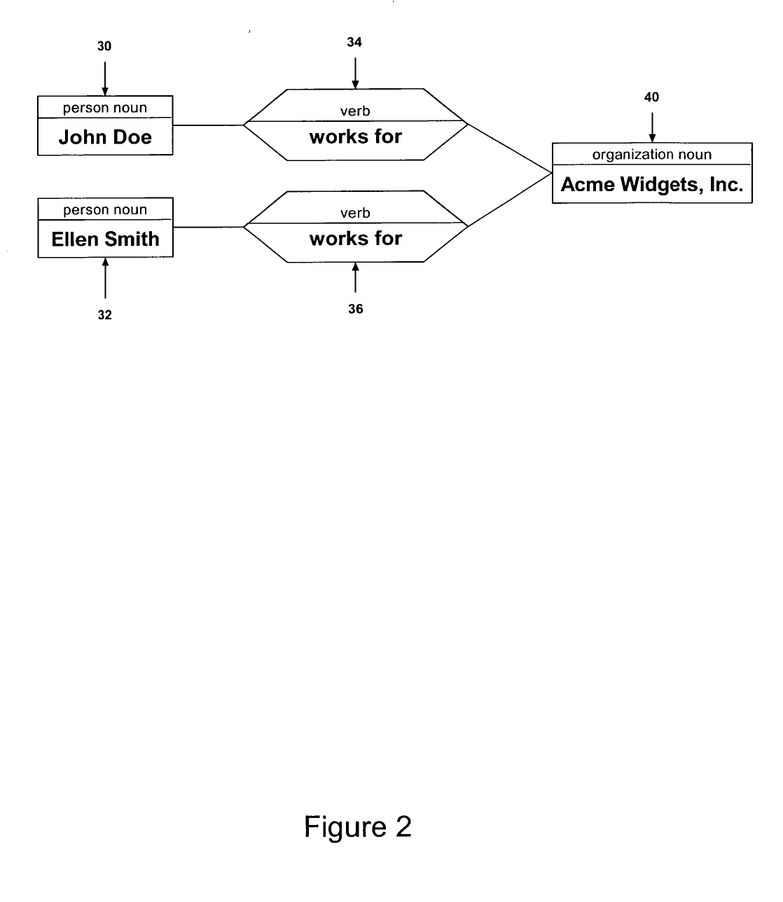

FIG. 2 illustrates how the disclosed system represents data it receives from the user using nouns and statements. As used herein, nouns may be people, places, things, qualities or actions. Statements are facts about nouns. For example, English sentences such as “John Doe works for Acme Widgets, Inc.,” and “Ellen Smith also works for Acme Widgets, Inc,” may be represented as statements. This information would be logically represented by the disclosed system as shown in FIG. 2, such that a noun 30 having a type “person” and a value of “John Doe” is linked through the verb “works for” 34 to a noun 40 of type “organization” having a value of “Acme Widgets, Inc.” Similarly, a noun 32 having a type “person” and a value of “Ellen Smith” is linked through a verb “works for” 36 to the noun 40 of type “organization” having the value “Acme Widgets, Inc.” Thus FIG. 2 shows how nouns are linked together through verbs contained in statements. This linking is performed through the definition of statements by the user, as further discussed below.

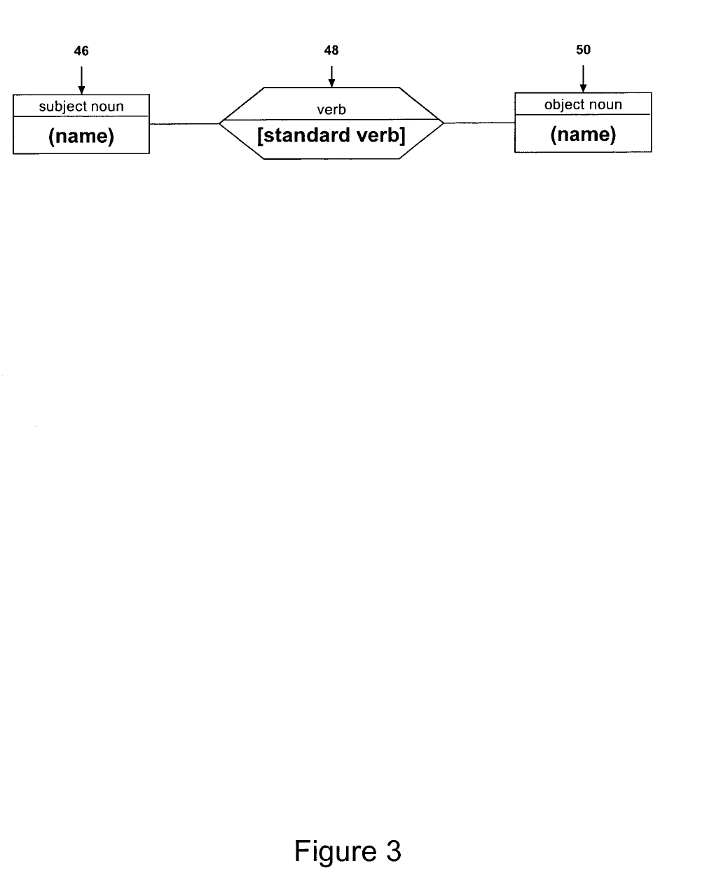

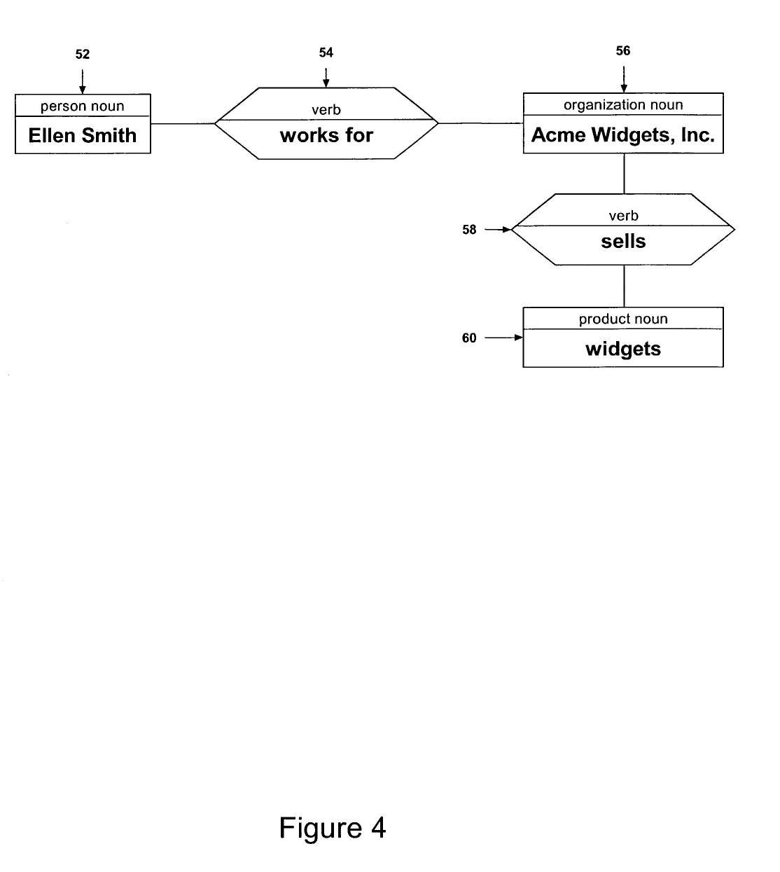

FIG. 3 illustrates the basic structure of a statement. As shown in FIG. 3, a statement includes a subject noun 46, named by the user, a verb 48, for example any standard verb, and an object noun 50, also named by the user. FIG. 4 shows that an object noun in one statement can be a subject noun in another statement. As shown in FIG. 4, a first statement might link the person type noun 52 having a value “Ellen Smith” through the verb “works for” 54 with the organization type noun 56 having the value “Acme Widgets, Inc.” At the same time, a second statement might link the product type noun 60 having a value of “widgets” with the organization noun 56 having a value of “Acme Widgets, Inc.” through the verb “sells” 58. During operation of the disclosed system, and as further described below, a user may simply click on nouns and verbs displayed in the user interface to include them in statements that the user defines.

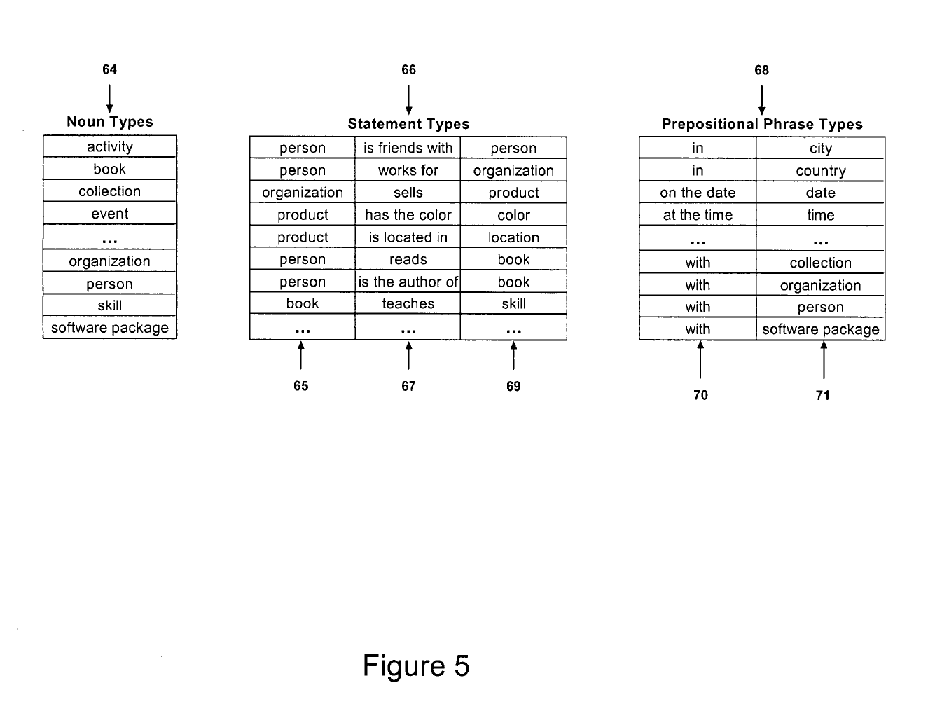

FIG. 5 shows an example of tables 64, 66 and 68 that store noun types, statement types, and prepositional phrase types respectively. Each entry (row) in the noun types table 64 defines a predetermined noun type, each entry (row) in the statement types table 66 defines a predetermined statement type, and each entry (row) in the prepositional phrase type table 68 defines a predetermined prepositional phrase type. Each entry in the statement types table 66 defines a relationship between a subject noun type 65, a verb 67, and an object noun type 69. Each user defined statement must conform to one of the statement types defined in the statement types table 66. While the user can define his or her own noun instances that are of the predetermined noun types defined in the table 64, the user cannot modify the set of verbs in the column 67.

Each entry in the prepositional phrase type table 68 defines a relationship between a predetermined preposition type in the column 70 and a noun type defined in the column 71. The set of preposition types in the column 70 are predetermined, and cannot be modified by a user.

The disclosed system uses a fixed grammar based on predetermined types, as illustrated in FIG. 5. In one embodiment, the disclosed system includes 150 predetermined noun types, 35,000 predetermined statement types, and 480 prepositional phrase types. All of the predetermined noun types, statement types, and prepositional phrase types are defined in the software prior to run time, and cannot be modified by a user. The use of a fixed grammar enables the user to conveniently enter data into the system without having to define the fields or records of a database schema.

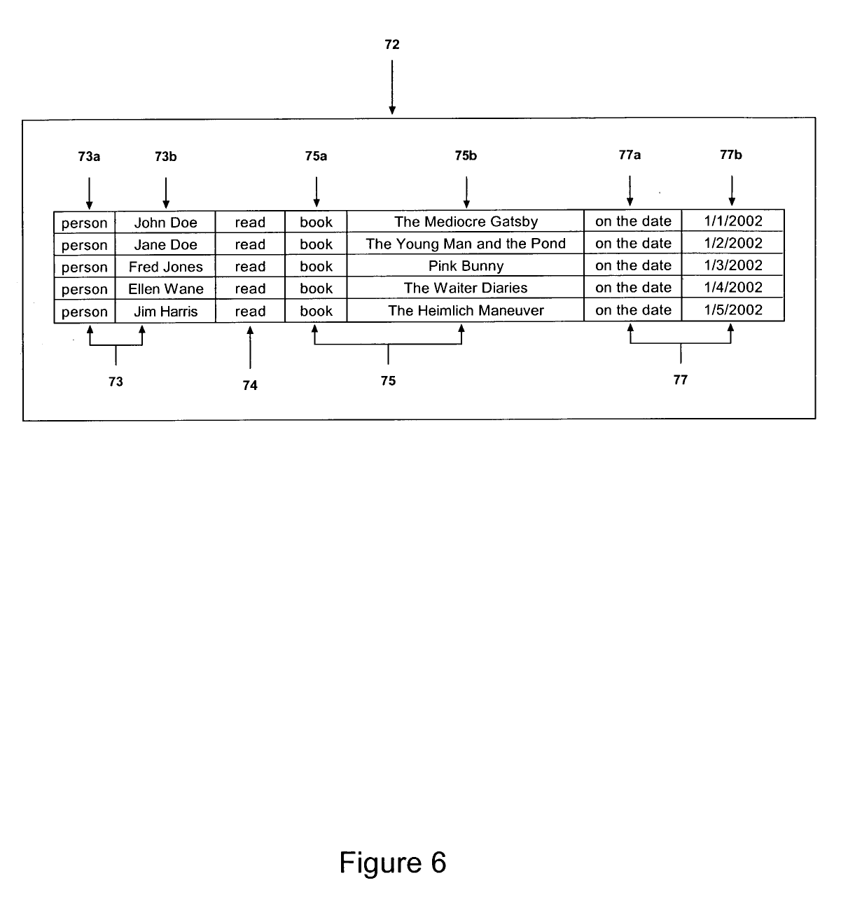

The disclosed system enables a user to freely define the values (or “names”) of specific noun instances (“nouns”). For example, the disclosed system allows a user to create a relational database containing, among other things, information regarding which people have read which books. In such a case, the user would define nouns for all the people referenced in the database using the predetermined noun type “person.” The user would further define nouns for all the books referenced within the database using the predetermined noun type “book.” Additionally, the user would define a number of statements having a type of “person reads book.” Moreover, each statement defined by the user in this regard could include a prepositional phrase of a prepositional phrase type in which the preposition consists of “on the date”, and the object of preposition noun type is “date.” For example, a table of statements 72 as shown in FIG. 6 would result from such activity. As shown in FIG. 6, a table 72 includes a number of rows, each of which contains a definition of a statement. Each statement in the table 72 includes a subject noun 73 having a noun type 73a and a value 73b, a verb 74, an object noun 75 having a noun type 75a and a value 75b, and a prepositional phrase 77 including a preposition 77a and an object of preposition noun value 77b. As shown in FIG. 6, with regard to the statements in the table 72, each of the subject nouns is of type “person”, each of the verbs is “read”, each of the object nouns are of type “book”, and each of the prepositions include the preposition “on the date” and an object of preposition noun of type “date”. The statements thus are shown to each include a subject noun, verb and object noun that conform to a predetermined statement type in the statement types table 66 of FIG. 5, and a prepositional phrase conforming to one of the prepositional phrase types shown in the prepositional phrase type table 68 also shown in FIG. 5. Thus it is shown that correctly typed prepositional phrases can be added to any conformant statement, without regard to the statement type.

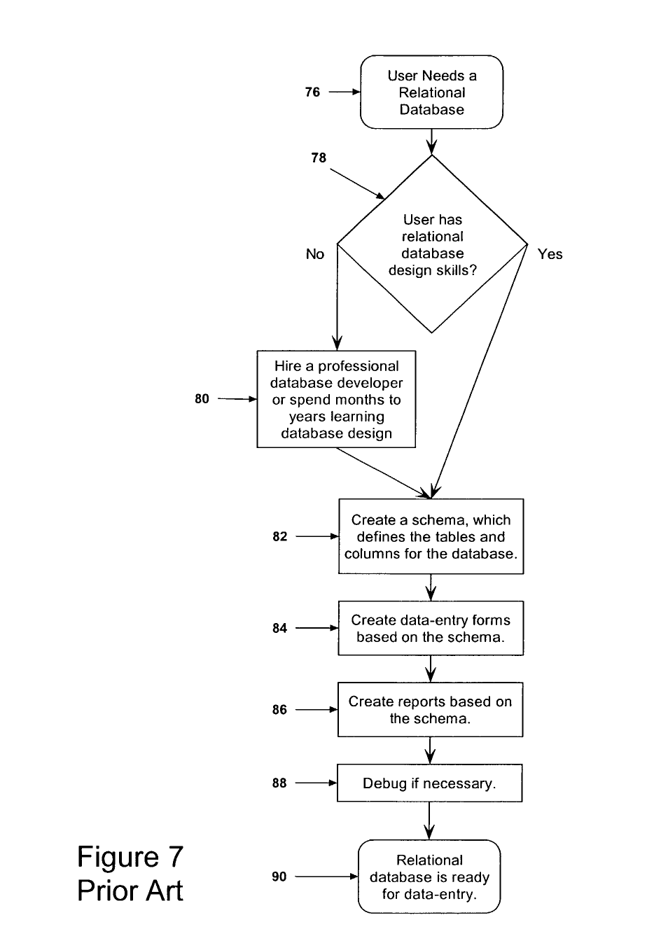

FIG. 7 is a flow chart showing steps performed by prior art systems to create a relational database. As shown in FIG. 7, at step 76 the user determines that they need a relational database system. Step 76 is followed by step 78, at which a determination is made as to whether the user has relational database design skills. If the user has relational database design skills, then step 78 is followed by step 82. Otherwise, at step 80 a professional database developer must be hired, or the necessary skills learned. At step 82, a schema is created, which defines the tables and columns for the database. Next, at step 84, data-entry forms are created based on the schema developed at step 82. At step 86, reports are generated based on the schema, and debugging may be performed at step 88. Finally, at step 90 the relational database is ready for data entry.

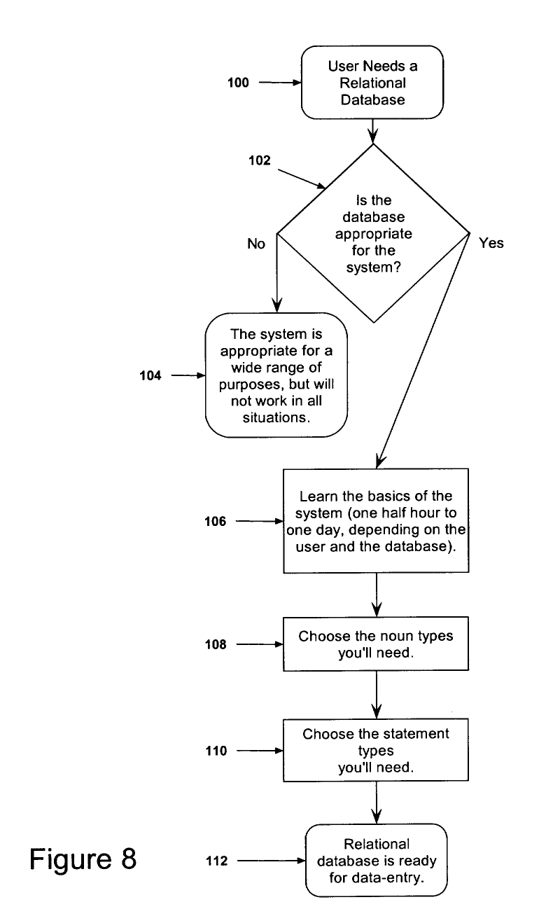

By way of contrast to the steps of FIG. 7, FIG. 8 shows a flow chart of steps performed by an embodiment of the disclosed system to create a relational database. Again, at step 100, the user determines that he or she needs a relational database. At step 102, the user determines whether the present system is appropriate for his or her needs.

The range of databases that can be created using the system is very wide, but does not include all databases. In summary, the system is appropriate for any database where the user needs to store items (people, organizations, books, concepts, etc.) and the relationships between these items (people read books, organizations sell books, books teach concepts, etc.).

If the system is not appropriate for the user's needs, then another system is selected at step 104. Otherwise, at step 106, the user takes the relatively small amount of time to learn the disclosed system, and then immediately proceeds to step 108, in which the user begins selecting the noun types from the predetermined set of noun types, and step 110, in which the user selects the statement types from the predetermined set of statement types. The user can then begin entering in data to the database using the disclosed system at step 112.

The disclosed system requires that all data entered by a user into the database (or “model”) be in the form of nouns or statements. As mentioned above, nouns may be people, places, things, qualities or actions, and statements are facts about nouns. Statements employed in the disclosed system include a subject noun, a verb, an object noun, and optionally one or more prepositional phrases. Accordingly, the name “John Doe” would be defined as the value of a noun of type “person”. The following data:

John Doe (subject noun) works for (verb) Acme Widgets Corporation (object noun)

may therefore be stored as a statement. Every noun added to a database generated by the disclosed system has a noun type. “John Doe” would naturally be defined by a user as a noun of type “person”. “Acme Widgets Corporation” would similarly be defined as a noun of type “organization”.

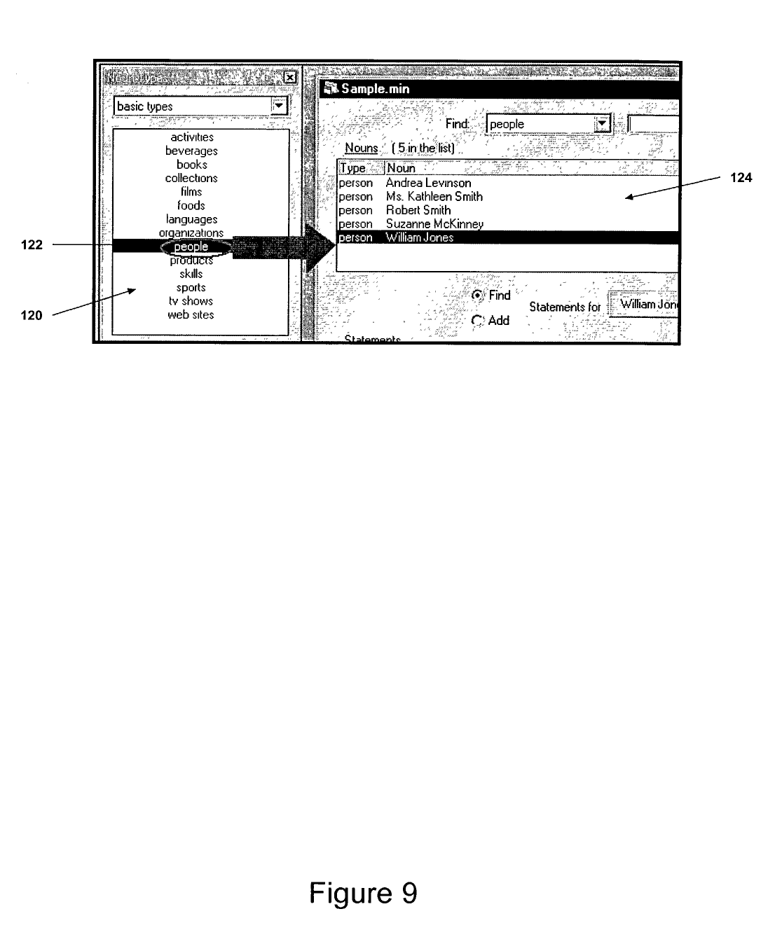

As a result of the disclosed fixed grammar, in which all noun types are predetermined before run time, all user defined nouns of a given type can conveniently be displayed to a user for inspection, or searched. FIG. 9 shows a graphical display from the disclosed user interface in which a window 120 displays some subset of the predetermined noun types. From within the window 120, the user can select, for example by clicking, one of the predetermined noun types. A selected noun type of people 122 is shown for purposes of explanation in FIG. 9. As a result of the user selection of the people noun type 122, the disclosed system displays, all the nouns that have been defined of the people noun type in a second display window 124. The user can then select one of the nouns shown in the window 124, in order to cause the disclosed system to display all statements including that noun. Similarly, the user may enter the noun name by typing, and then click on a button in the user interface to cause the disclosed system to display all people nouns matching that entry.

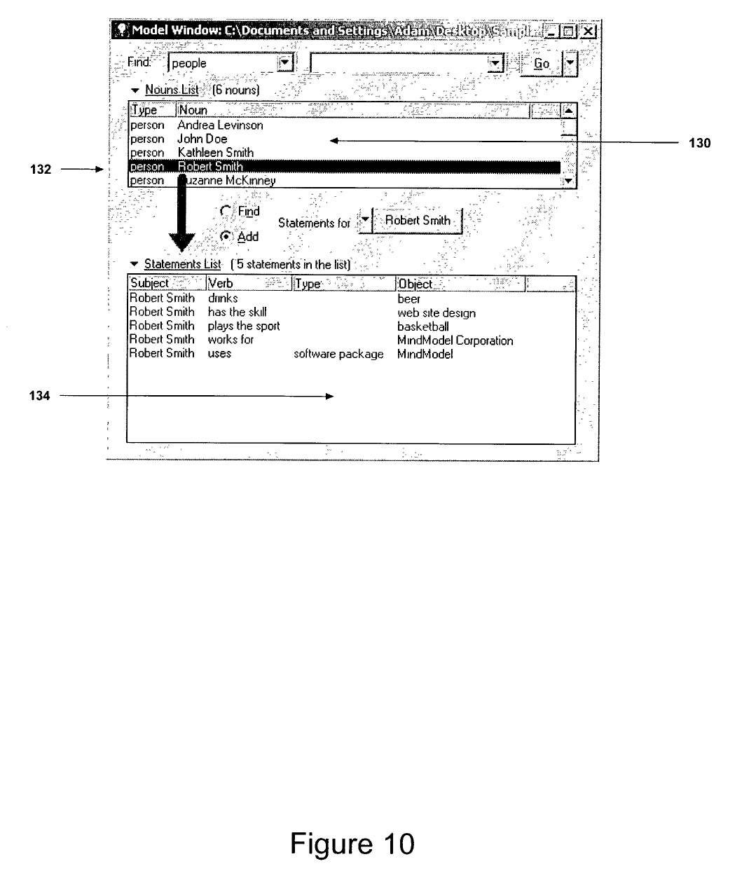

The disclosed system provides the user with a powerful way of searching for related information. Since the disclosed system uses verbs to express relations in statements, entering and browsing related information is relatively simple. For example, as shown in FIG. 10, in order to find all the information related to a specific person, a user can simply double-click on that person's name 132 in a list 130 that displays the nouns of type person. Since the disclosed system stores information from the user according to the disclosed fixed grammar, all the software must do is search for statements which relate to the double-clicked noun (in this case “Robert Smith”). The results are presented to the user in the form of statements in the list 134. The user can then narrow the results by specifying parts of the statements to match. For example, the user could request for all statements related to Robert Smith which contain the verb “works for”.

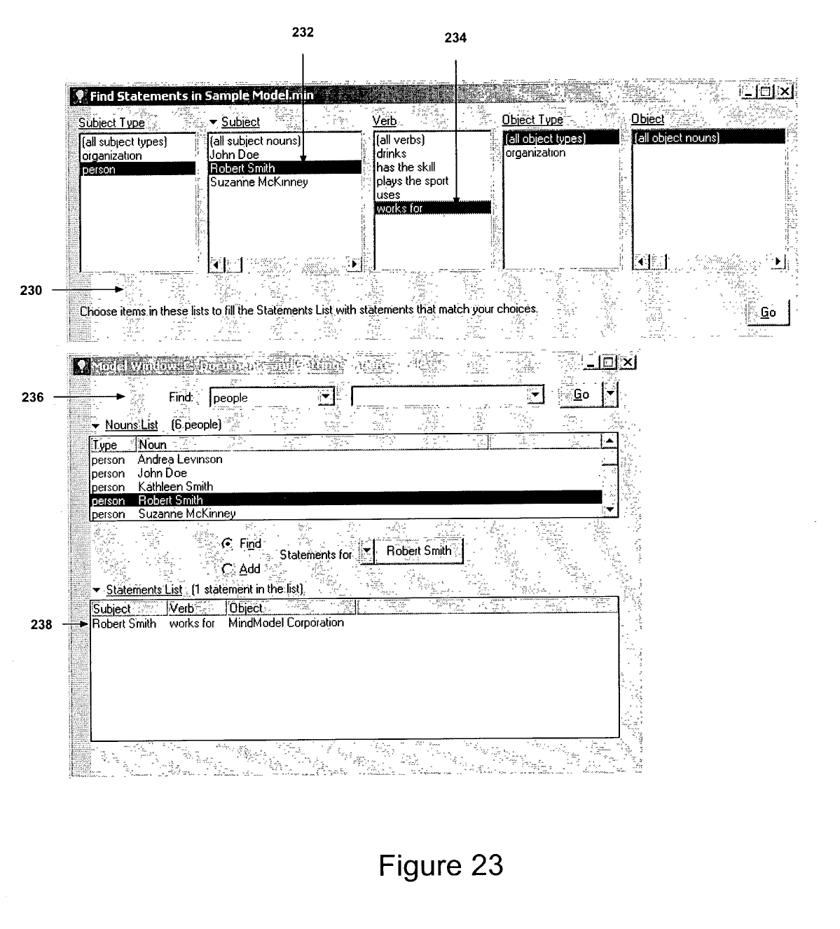

FIG. 23 shows this interaction. The user selects the person “Robert Smith” 232 and the verb “works for” 234 in the window 230. The software displays the results in a second window 236. The software displays the statement 238 that matches the user's query (find statements which have the person “Robert Smith” as the subject and “works for” as the verb).

Significantly, no special forms, additional tables, or searching code need to be created by a programmer for the user to provide these features using the present system. Since the disclosed system stores all its data based on the predetermined grammar, the data can be searched from any direction.

In FIG. 10, the list 134 displays all statements related to Robert Smith. Notice that the statements themselves refer to other nouns. Accordingly, the user could double-click on the skill “web site design” to see all statements about that skill.

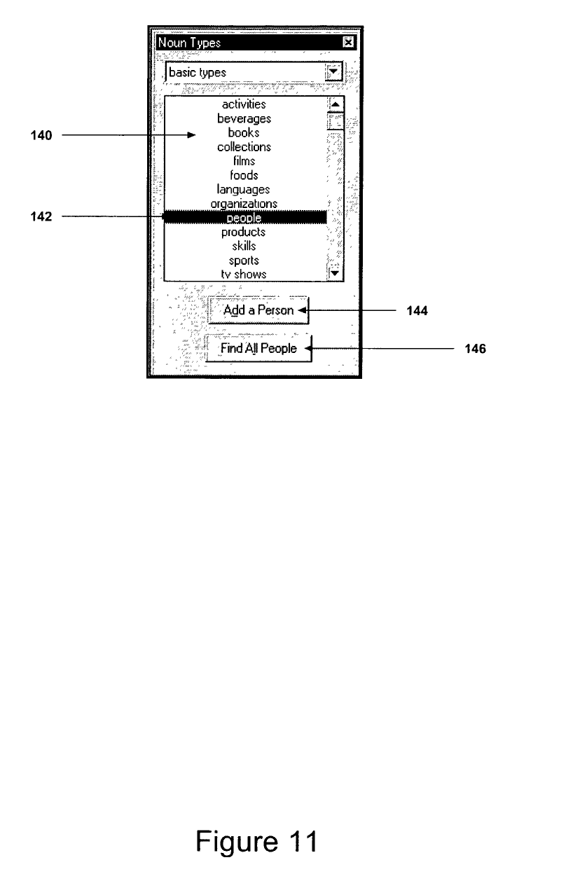

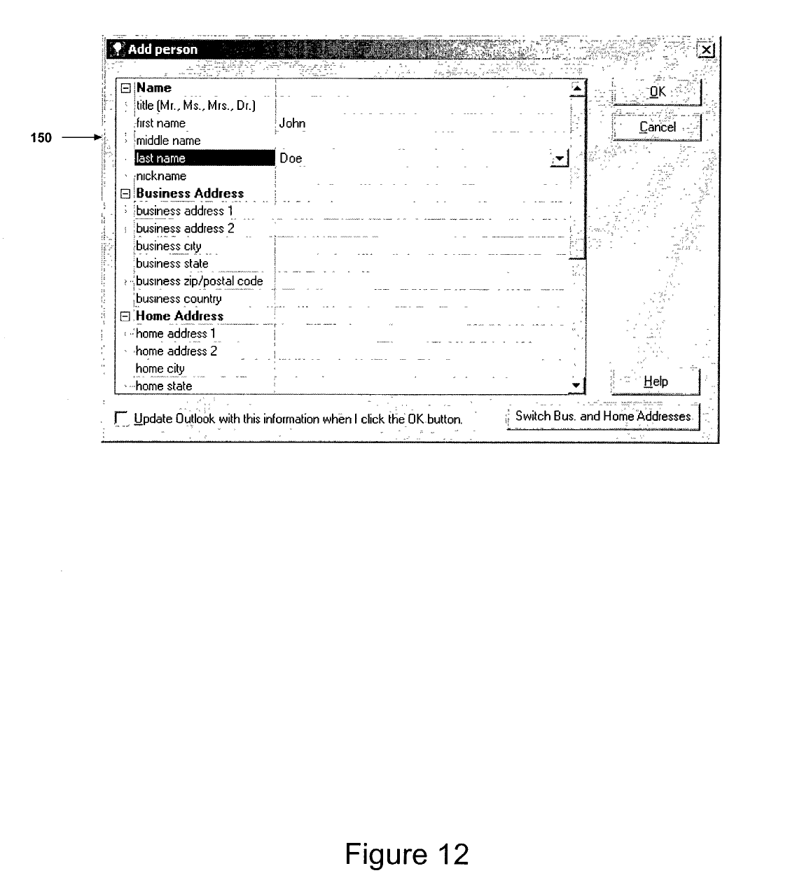

FIGS. 11 through 19 are screen displays illustrating operation of the disclosed system to enter data into a database. As mentioned above, the disclosed system requires that all data entered into a database (or “model”) generated by the disclosed system be in the form of nouns and/or statements. In order to enter information into the database using the disclosed system, the user starts by selecting a noun to use at the beginning of the statement, referred to as the “subject noun.” This may be accomplished as shown in FIG. 11 by clicking on a noun type 142 from within a display of noun types 140. Once the user has chosen a subject noun type, the user can either add a new noun of that type by clicking an add button 144, or select from within the existing nouns of that type by clicking a find button 146. If the user clicks on the add button 144, a new display screen, such as the display 150 shown in FIG. 12, is displayed through which the user can provide information relevant to nouns of the previously selected type.

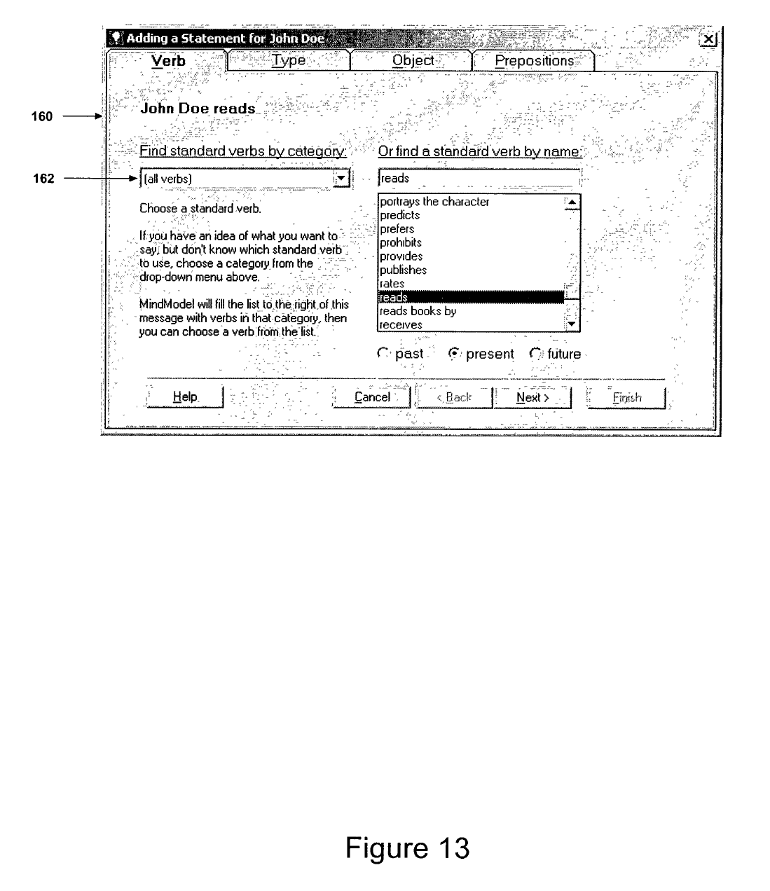

After the user has entered the required information through the display 150, the subject noun for a statement has been defined. The next step is for the system to obtain a verb for the statement. The disclosed system uses its fixed grammar to determine which of the predetermined verbs are permitted in a statement starting with the previously defined subject noun type. As shown in FIG. 13, a screen display 160 is generated by the disclosed system to enable the user to select one of the permitted verbs as the verb for the statement. The screen display 160 includes a drop-down menu 162 through which the user can select categories of permitted verbs to browse.

The total set of permitted verbs from which the user can select consists of those verbs present in statement type definitions having a subject noun type matching the noun type of the previously defined subject noun. For example, if the subject noun is a person type noun, the set of permitted verbs might include verbs such as “reads”, “works for”, “likes”, etc. If the subject noun were a book type noun, the set of permitted verbs would be different. Predefined verbs for statements having book type subject nouns might include “is a sequel to”, “costs”, and “has the ISBN number”.

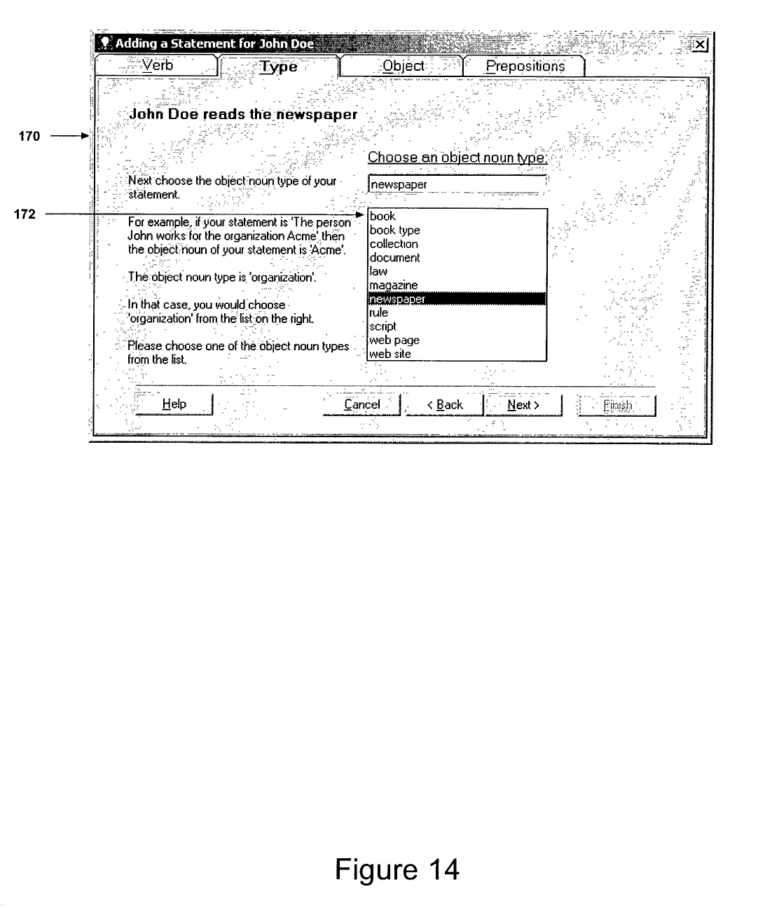

Once the user has chosen a subject noun and a verb, the next step is for the disclosed system to enable the user to select an object noun type. As shown in FIG. 14, a screen display 170 may be employed to provide a list 172 of permitted object noun types from which the user may select by clicking. the set of permitted object noun types displayed in the list 172 includes noun types contained in statement types containing the subject noun type of the subject noun, and the verb previously selected by the user. For example, if the previously selected subject noun is a person type noun (“John Doe”), and the previously selected verb is “reads”, the statement types in the fixed grammar might permit object noun types including: “book”, “document”, “magazine”, or “Web site”, since these are all things that people might read. For purposes of explanation, the screen display 170 in FIG. 14 is shown having the object noun type of “newspaper” selected.

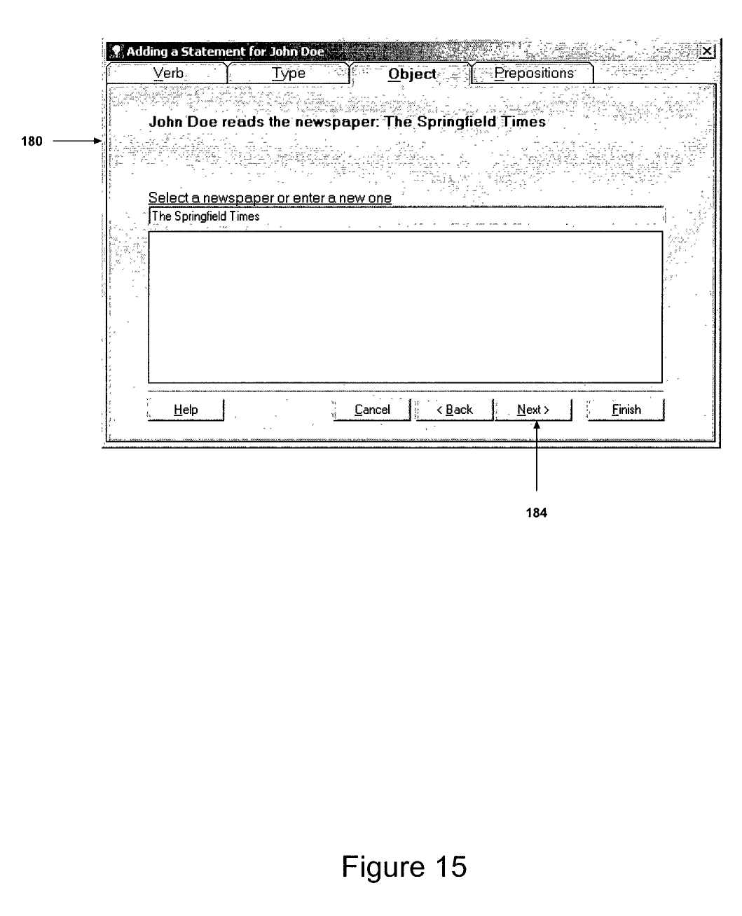

Next, the user is provided with the ability to either select or define an object noun that for the statement. As shown in FIG. 15, a screen display 180 is generated, enabling the user to enter a noun value into the text entry box. For example, the user has entered “Springfield Times”.

The user then has the option whether or not to add a prepositional phrase to the statement. If the user does not wish to add a prepositional phrase to the statement, the user would click Finish to complete the statement. In our example, the user does want to add a prepositional phrase to the statement, so the user clicks the Next button 184.

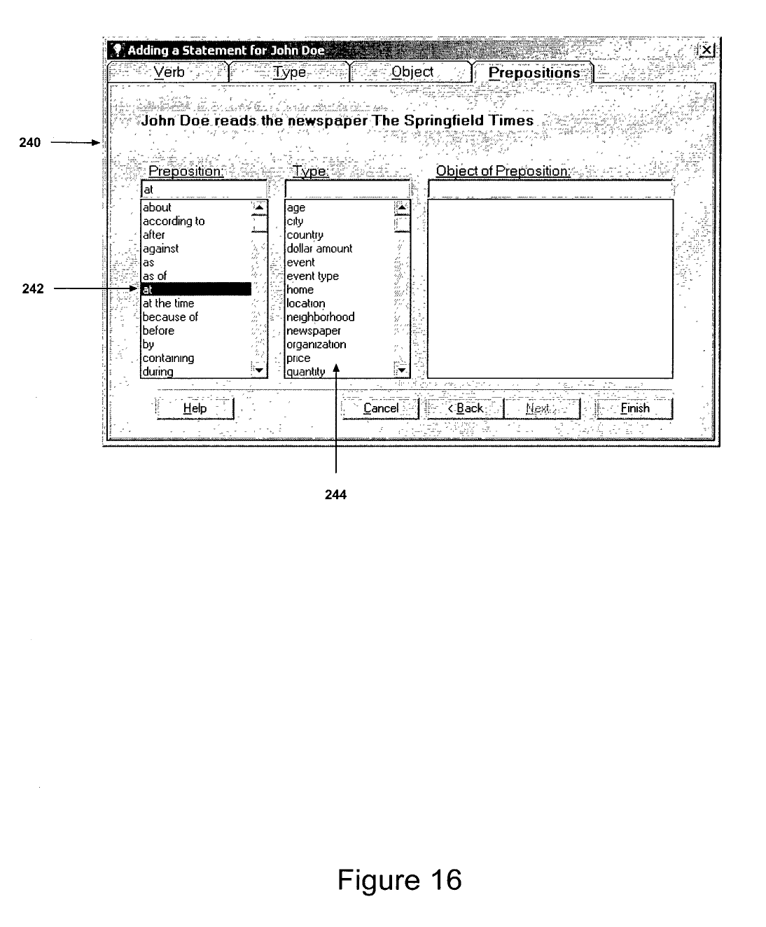

The next step is for the disclosed system to present a screen 240 pictured in FIG. 16. This screen allows the user to add a prepositional phrase to the statement. First the user chooses a preposition type 242, in this case “at”.

The system then displays a subset of the noun types (in list 244) called the “object of preposition noun types” which correspond to the preposition type “at”. The preposition type 242 and object of preposition noun types 244 together form meaningful prepositional phrases such as: “at the age”, “at the city”, “at the country”, etc.

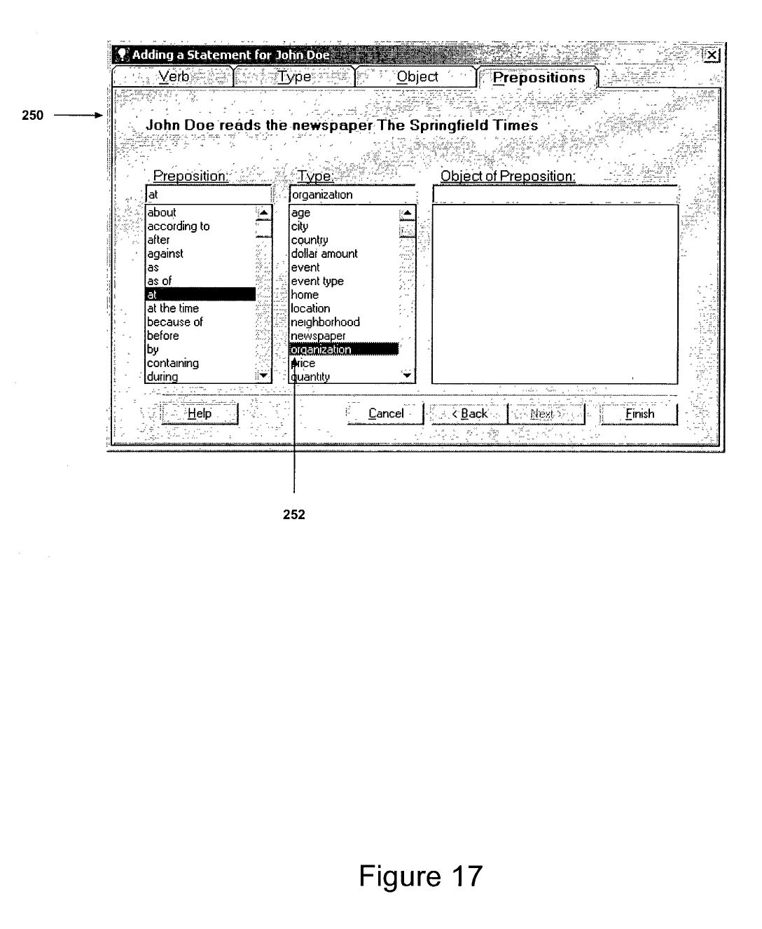

FIG. 17 shows the next step, where the user has chosen the object of preposition noun type 252 “organization” on the screen 250.

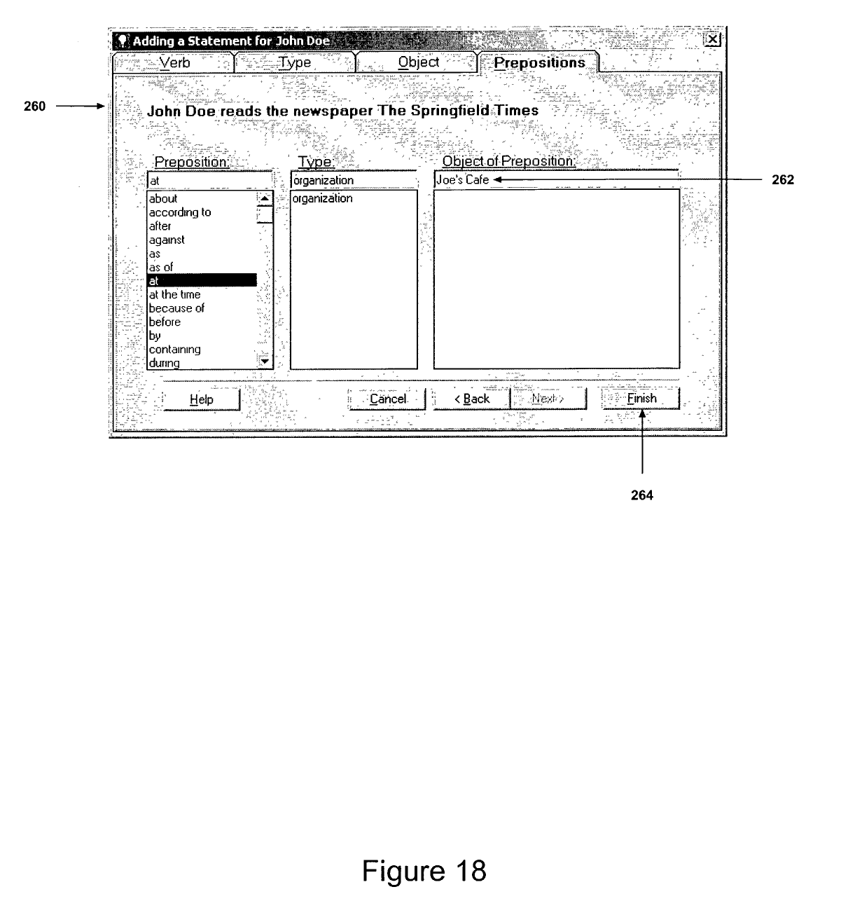

FIG. 18 shows the next step, where the user has entered the name of an organization 262 “Joe's Café”. This organization noun 262 is the object of the preposition “at”. If the desired object of preposition noun were already in the database, the user could have chosen it from the list below the entry 262.

Having specified a preposition type, object of preposition noun type and object of preposition noun 262, the prepositional phrase is complete. The user clicks the Finish button 264 to inform the system that the statement is complete.

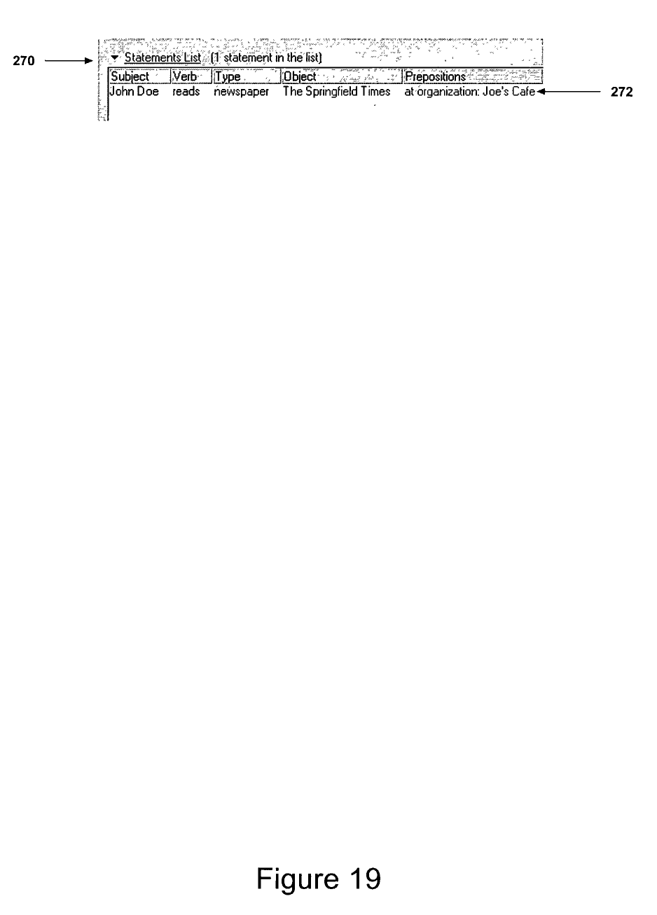

FIG. 19 shows the next screen 270 presented by the system which shows the completed statement: “John Doe reads the newspaper The Springfield Times at Joe's Café.”

As a result of the foregoing steps, three new nouns have been added to the database: a first noun having a value of “John Doe” and of type “person”, and a second noun having a value of “The Springfield Times” and type “newspaper”, and a third noun of type “organization” having a value of “Joe's Café”. Also, one statement has been added to the database:

“John Doe” (subject noun) “reads” (verb) “the Springfield Times” (object noun) at (preposition type) organization (object of preposition noun type) Joe's Café (object of preposition noun).

Although these three nouns have a particular place in this statement, each could occur in a different place in a different statement. For example, another statement could say that: “Joe's Café sells coffee.”

FIG. 19 illustrates the added statement in a screen display 270. After the statement 272 has been added to the database, when a user searches for statements related to the noun “John Doe”, or to the verb “the Springfield Times”, or to the verb “reads”, or to the noun “Joe's Café”, the new statement will be found and displayed to the user. Also, if the user looks for all nouns of type “person”, then the “John Doe” noun will be found. Similarly, if the user searches for all nouns that are of the type “newspaper”, the noun having the value of “The Springfield Times” would be found. If the user searches for all nouns that are of type “organization”, the noun “Joe's Café” would be found.

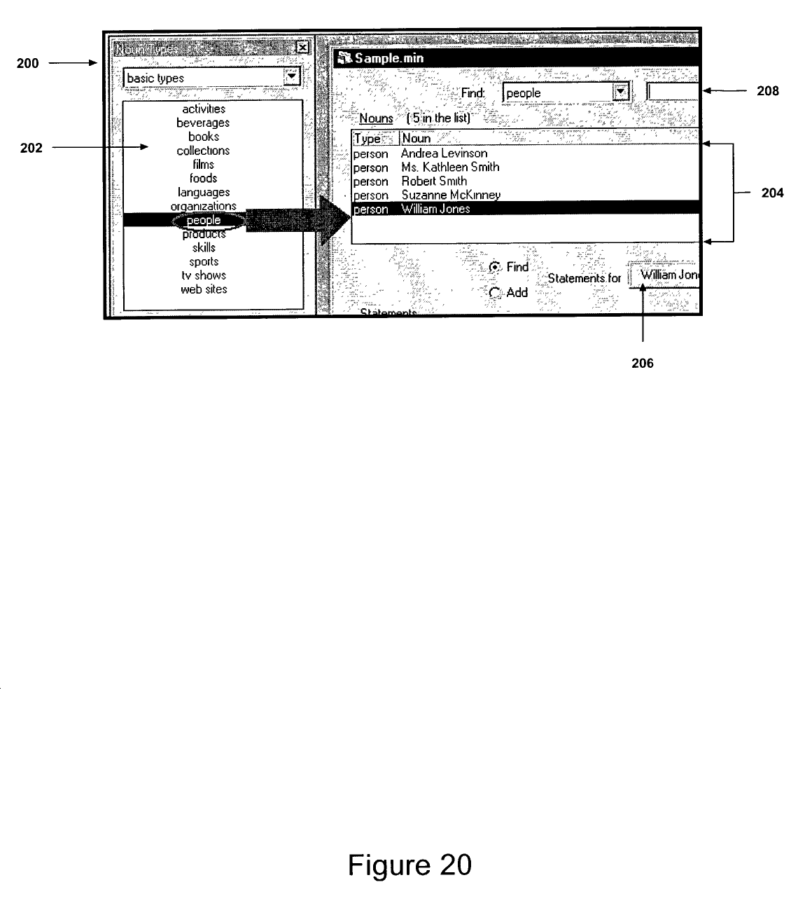

FIG. 20 is a screen display illustrating how user defined nouns can be searched in a database generated with the disclosed system. As shown in FIG. 20, a screen display 200 is disclosed including a list 202 through which noun types are displayed to the user. The user can select one of the noun types provided in the list 202 by double clicking on that category, causing all nouns that have been defined of that type to be displayed in a list 204. The user can then click on the button 206 to obtain a display of all the currently defined statements that relate to the noun selected in the list 204. In another feature of the disclosed system, the user can enter a search string into area 208 and then request that all nouns of the type selected in list 202 matching that string be displayed.

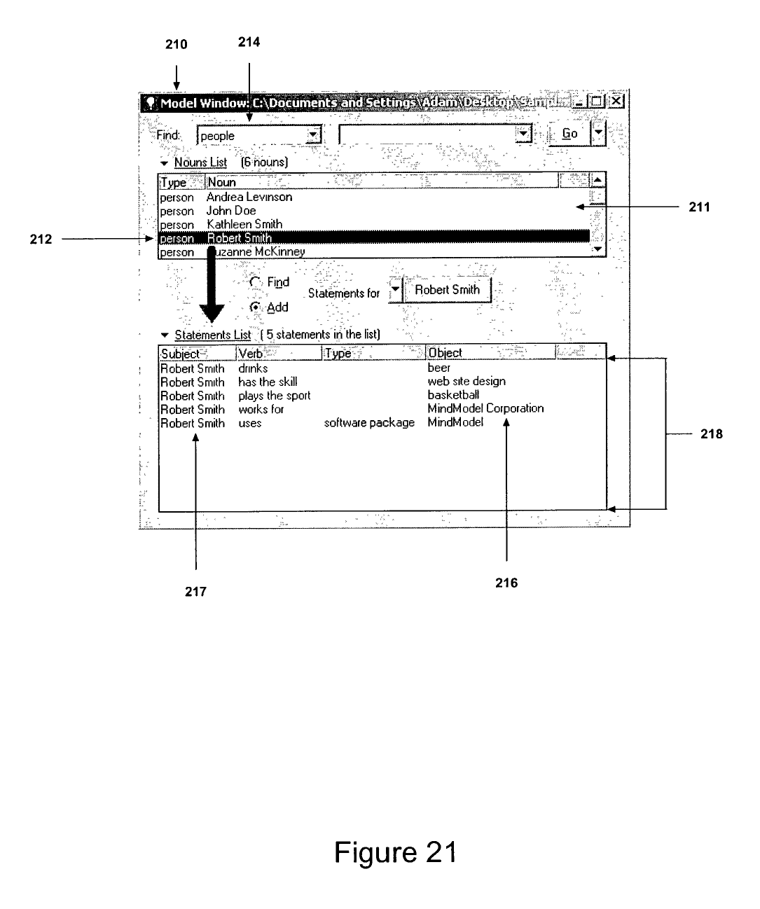

FIGS. 21 through 23 are screen displays illustrating how user defined statements can be found using the disclosed system. The fixed grammar of the disclosed system makes finding related information stored in the form of statements convenient and efficient. As shown in FIG. 21, a screen display includes a nouns list 211 which displays nouns of a type selected by the user through the drop-down menu 214. When the user double-clicks on a noun in the nouns list 211, all statements in which the selected noun is a subject, an object, or an object of a preposition are displayed in the statements list 218.

Moreover, the disclosed system further operates such that the user can select, for example by double clicking, any of the nouns in the statements in the statements list 218 in order to add them to the nouns list 211. This allows the user to then double-click on the noun in the nouns list 211 to find statements related to that noun.

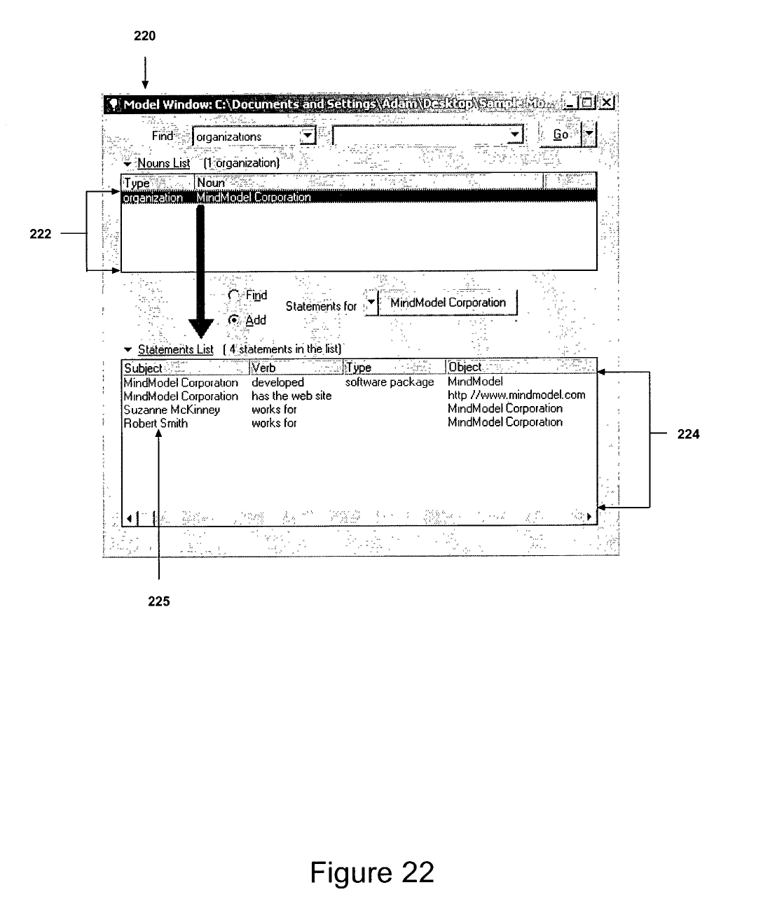

For example, should the user double click on the object noun “MindModel Corporation” 216, the disclosed system would add the noun to the nouns list 222 as shown in FIG. 22. The user could then double-click on the organization noun “MindModel Corporation” to display all statements related to that noun, as shown in the statements list 224 of FIG. 22.

The statement “Robert Smith” (subject noun) “works for” (verb) “MindModel Corporation” appears both as statement 217 in FIG. 21, and as statement 225 in FIG. 22. FIG. 21 shows all statements related to Robert Smith, and Robert Smith appears in this statement. FIG. 22 shows all statements related to MindModel Corporation, and MindModel Corporation also appears in this statement. Robert Smith is the subject noun. MindModel Corporation is the object noun.

Since the database is relational, this statement (“Robert Smith works for MindModel Corporation”) is only stored in the database once, but it appears in both queries.

Those skilled in the art should readily appreciate that programs defining the functions of the disclosed system and method can be implemented in software and delivered to a system for execution in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using baseband signaling or broadband signaling techniques, including carrier wave signaling techniques, such as over computer or telephone networks via a modem. In addition, while the illustrative embodiments may be implemented in computer software, the functions within the illustrative embodiments may alternatively be embodied in part or in whole using hardware components such as Application Specific Integrated Circuits, Field Programmable Gate Arrays, or other hardware, or in some combination of hardware components and software components.

While the invention is described through the above exemplary embodiments, it will be understood by those of ordinary skill in the art that modification to and variation of the above described methods and system may be made without departing from the inventive concepts herein disclosed. In particular, while the disclosed invention is described through embodiments in which English is used to define the types of the fixed grammar, and is stored within the generated database, it is not so limited. The disclosed system may alternatively be embodied using any language. Accordingly, the invention should not be viewed as limited except by the scope and spirit of the appended claims.

What is claimed is:

1. A method for organizing data into a database, comprising:
determining a subject noun type, wherein said subject noun type is one of a predetermined set of noun types;
determining a subject noun associated with said subject noun type;
determining, responsive to said subject noun type, a subset of a predetermined set of verbs, wherein for each verb in said subset there exists one statement type in a predetermined set of statement types including said subject noun type;
determining a selected one of said verbs in said subset of said predetermined set of verbs;
determining, responsive to said subject noun type and said selected verb, a first subset of said predetermined set of noun types, wherein for each noun type in said first subset of said predetermined set of noun types there exists one statement type in a predetermined set of statement types including said subject noun type, said selected verb, and said noun type in said first subset of said predetermined set of noun types;
determining an object noun type, wherein said object noun type is a selected one of said first subset of said predetermined set of noun types;
determining an object noun associated with said object noun type;
forming a statement including said subject noun, said selected verb, and said object noun; and
storing said statement as one of a plurality of statements representing said database.

2. The method for organizing data into a database of claim 1, further comprising:
determining a selected preposition type from a predetermined set of preposition types;
determining, responsive to said selected preposition type, a second subset of said predetermined set of noun types, wherein for each noun type in said second subset of said predetermined set of noun types there exists one prepositional phrase type in a predetermined set of prepositional phrase types including said selected preposition type and said noun type in said second subset of said predetermined set of noun types;
determining an object of preposition noun type, wherein said object of preposition noun type is one of said second subset of said predetermined set of noun types;
determining an object of preposition noun, wherein said object of preposition noun is associated with said object of preposition noun type; and
wherein said statement further includes a prepositional phrase including said selected preposition type and said object of preposition noun.

3. The method for organizing data into a database of claim 1, further comprising displaying said predetermined set of noun types in a user interface and detecting a user selection of said subject noun type through said user interface.

4. The method for organizing data into a database of claim 1, wherein said determining said subject noun comprises detecting a user indication of a previously defined noun of said subject noun type.

5. The method for organizing data into a database of claim 1, wherein said determining said subject noun comprises detecting a newly entered noun of said subject noun type.

6. The method for organizing data into a database of claim 1, wherein said subject noun type determines a display of said subset of said predetermined set of verbs.

7. The method for organizing data into a database of claim 1, wherein said determining said selected one of said subset of said predetermined set of verbs comprises displaying said subset of said predetermined set of verbs through a user interface and detecting a user selection of said selected one of said subset of said predetermined set of verbs.

8. The method for organizing data into a database of claim 1, wherein said determining said object noun type comprises displaying said subset of said predetermined set of noun types through a user interface and detecting a user selection of said object noun type from said subset of said predetermined set of noun types.

9. The method for organizing data into a database of claim 1, wherein said determining said object noun comprises detecting a user indication of a previously defined noun of said object noun type.

10. The method for organizing data into a database of claim 1, wherein said determining said object noun comprises detecting a newly entered noun of said object noun type.

11. The method for organizing data into a database of claim 2, wherein said determining said selected preposition type comprises displaying said predetermined set of preposition types through a user interface and detecting a user selection of one of said predetermined set of preposition types through said user interface.

12. The method for organizing data into a database of claim 2, wherein said determining said object of preposition noun type comprises displaying said second subset of said predetermined set of noun types through a user interface and detecting a user selection of said object of preposition noun type.

13. The method for organizing data into a database of claim 2, wherein said determining said object of preposition noun comprises detecting a user indication of a previously defined noun of said object of preposition noun type.

14. The method for organizing data into a database of claim 2, wherein said determining said object of preposition noun comprises detecting a newly entered noun of said object of preposition noun type.

15. The method for organizing data into a database of claim 1, further comprising user indication of a part of a statement to display information from said database related to said part of said database.

16. The method for organizing data into a database of claim 2, wherein existing data is exported into a format indicating said subject noun type, subject noun, said verb, said object noun type, object noun, and said prepositional phrase.

17. A system for organizing data into a database, wherein said system, includes program code stored in a computer program storage device, said program code comprising:
program code for determining a subject noun type, wherein said subject noun type is one of a predetermined set of noun types;
program code for determining a subject noun associated with said subject noun type;
program code for determining, responsive to said subject noun type, a subset of a predetermined set of verbs;
program code for determining a selected one of said verbs in said subset of said predetermined set of verbs;
program code for determining, responsive to said subject noun type and said selected verb, a first subset of said predetermined set of noun types, wherein for each noun type in said first subset of said predetermined noun types there exists one statement type in a predetermined set of statement types including said first subject noun type, said selected verb, and said noun type in said first subset of said predetermined noun types;
program code for determining an object noun type, wherein said object noun type is a selected one of said first subset of said predetermined noun types;
program code for determining an object noun associated with said object noun type;
program code for determining a selected preposition type from a predetermined set of preposition types;
program code for determining, responsive to said selected preposition type, a second subset of said predetermined set of noun types, wherein for each noun type in said second subset of said predetermined noun types there exists one prepositional phrase type in a predetermined set of prepositional phrase types including said selected preposition type and said noun type in said second subset of said predetermined noun types;
program code for determining an object of preposition noun type, wherein said object of preposition noun type is one of said second subset of said predetermined set of noun types;
program code for determining an object of preposition noun, wherein said object of preposition noun is of said object of preposition noun type;
program code for forming a statement including said subject noun, said verb, said object noun, said preposition type and said object of preposition noun; and
program code for storing said statement as one of a plurality of statements representing said database.

18. The system of claim 17, further comprising:
program code for importing data consisting of said subject noun types, said subject nouns, said verbs, said object noun types, said object nouns, said preposition types, said object of preposition noun types, and said object of preposition nouns.

19. The system of claim 17, wherein said program storage device comprises a program memory, and wherein said system further comprises at least one processor coupled to said program memory.

20. A computer program product, including a computer readable medium, said computer readable medium having a computer program stored thereon, said computer program for organizing data into a database, said computer program comprising:
program code for determining a subject noun type, wherein said subject noun type is one of a predetermined set of noun types;
program code for determining a subject noun associated with said subject noun type;
program code for determining, responsive to said subject noun type, a subset of a predetermined set of verbs,
program code for determining a selected one of said verbs in said subset of said predetermined set of verbs;
program code for determining, responsive to said subject noun type and said selected verb, a first subset of said predetermined set of noun types, wherein for each noun type in said first subset of said predetermined noun types there exists one statement type in a predetermined set of statement types including said first subject noun type, said selected verb, and said noun type in said first subset of said predetermined noun types;
program code for determining an object noun type, wherein said object noun type is a selected one of said first subset of said predetermined noun types;
program code for determining an object noun associated with said object noun type;
program code for determining a selected preposition type from a predetermined set of preposition types; program code for determining, responsive to said selected preposition type, a second subset of said predetermined set of noun types, wherein for each noun type in said second subset of said predetermined noun types there exists one prepositional phrase type in a predetermined set of prepositional phrase types including said selected preposition type and said noun type in said second subset of said predetermined noun types;
program code for determining an object of preposition noun type, wherein said object of preposition noun type is one of said second subset of said predetermined set of noun types;
program code for determining an object of preposition noun, wherein said object of preposition noun is of said object of preposition noun type;
program code for forming a statement including said subject noun, said verb, said object noun, said preposition type and said object of preposition noun; and
program code for storing said statement as one of a plurality of statements representing said database.

21. A system for organizing data into a database, comprising:
means for determining a subject noun type, wherein said subject noun type is one of a predetermined set of noun types;
means for determining a subject noun associated with said subject noun type;
means for determining, responsive to said subject noun type, a subset of a predetermined set of verbs,
means for determining a selected one of said verbs in said subset of said predetermined set of verbs;
means for determining, responsive to said subject noun type and said selected verb, a first subset of said predetermined set of noun types, wherein for each noun type in said first subset of said predetermined noun types there exists one statement type in a predetermined set of statement types including said first subject noun type, said selected verb, and said noun type in said first subset of said predetermined noun types;
means for determining an object noun type, wherein said object noun type is a selected one of said first subset of said predetermined noun types;
means for determining an object noun associated with said object noun type;
means for determining a selected preposition type from a predetermined set of preposition types;
means for determining, responsive to said selected preposition type, a second subset of said predetermined set of noun types, wherein for each noun type in said second subset of said predetermined noun types there exists one prepositional phrase type in a predetermined set of prepositional phrase types including said selected preposition type and said noun type in said second subset of said predetermined noun types;
means for determining an object of preposition noun type, wherein said object of preposition noun type is one of said second subset of said predetermined set of nouns;
means for determining an object of preposition noun, wherein said object of preposition noun is of said object of preposition noun type;
means for forming a statement including said subject noun, said verb, said object noun, said preposition type and said object of preposition noun; and
means for storing said statement as one of a plurality of statements representing said database.
